(19) United States
(12) Patent Application Publication
(10) Pub. No.: US 2022/0408957 A1
(43) Pub. Date: Dec. 29, 2022

(54) MOTORIZED DRIVE DEVICE OF AN OCCULTATION OR SUNSCREEN DEVICE, OCCULTATION OR SUNSCREEN DEVICE AND ASSOCIATED INSTALLATION

(71) Applicant: SOMFY ACTIVITES SA, Cluses (FR)

(72) Inventors: Norbert DUPIELET, Cluses (FR); Eric LAGARDE, Cluses (FR)

(21) Appl. No.: 17/780,919

(22) PCT Filed: Nov. 27, 2020
(86) PCT No.: PCT/EP2020/083732

§ 371 Date: May 27, 2022

(30) Foreign Application Priority Data
Nov. 29, 2019 (FR) FR1913486

(51) Int. Cl. A47H 5/02; A47H 1/06

(52) U.S. Cl. CPC A47H 5/02; A47H 1/06; A47H 2005/025

(57) ABSTRACT

A motorized drive device includes an electric motor, a first holding device and a first switching mechanism. In a first position of the first mechanism, a first guide wheel of the first holding device is offset relative to a second guide wheel of the first holding device, so as to hold the motorized drive device relative to a rail by supporting the first and second guide wheels with respective first and second tracks of the rail. Furthermore, in a second position of the first mechanism, the first guide wheel is positioned opposite the second guide wheel, in a direction of movement of the motorized drive device along the rail, so as to insert or extract the first and second guide wheels into or from the rail, through a slot of the rail.

### CROSS-REFERENCE TO RELATED APPLICATIONS

This application is the U.S. national phase of International Application No. PCT/EP2020/083732 filed Nov. 27, 2020 which designated the U.S. and claims priority to FR 1913486 filed Nov. 29, 2019, the entire contents of each of which are hereby incorporated by reference.

### BACKGROUND OF THE INVENTION

### Field of the Invention

The present invention relates to a motorized drive device of an occultation or solar protection device, provided to move at least one screen along a rail following a sliding movement.

The present invention also relates to an occultation or solar protection device equipped with such a motorized drive device, as well as a home automation installation comprising such an occultation or solar protection device.

The present invention relates generally to the field of curtains comprising a motorized drive device moving a screen relative to a rail in a sliding movement, between at least a first position and at least a second position.

### Description of the Related Art

JP 2017 176 425 A, which describes a motorized drive device of an occultation or solar protection device, is already known. The motorized drive device comprises an electric motor, a drive wheel, a first holding device and a first switching mechanism. The drive wheel is configured to be rotated by the electric motor and to be brought into contact with a running surface of a rail of the occultation device, so as to move the motorized drive device along the rail in a direction of movement. The first holding device comprises first and second guide wheels. The first and second guide wheels are configured to be inserted into or extracted from the rail, through a slot of the rail, and to be brought into contact with at least one of the respective first and second tracks of the rail, so as to hold or release the motorized drive device relative to the rail. The first switching mechanism is configured to drive the first and second guide wheels of the first holding device between a first position and a second position, and vice versa.

However, this motorized drive device has the disadvantage of rotating the first and second guide wheels of the first holding device simultaneously, about an axis of rotation orthogonal to the running surface of the rail, so as to enable the insertion or extraction thereof from the rail, through the slot in the rail.

Thus, the first and second guide wheels of the first holding device have a diameter smaller than the width of the slot of the rail.

Such a diameter of the first and second guide wheels of the first holding device adversely affects the efficiency of the motorized drive device, during electrical activation of the electric motor, due, in particular, to defects in the shape or flatness of the first and second tracks of the rail, for example holes formed therein. These defects in the first and second tracks of the rail can thus cause resistance to the movement of the motorized drive device relative to the rail, during electrical activation of the electric motor.

### SUMMARY OF THE INVENTION

The object of the present invention is to solve the above-mentioned drawbacks and to provide a motorized drive device of an occultation or solar protection device, an occultation or solar protection device comprising such a motorized drive device, as well as a home automation installation comprising such an occultation or solar protection device, that makes it possible to facilitate the insertion or extraction of guide wheels of a holding device of the motorized drive device relative to a rail of the occultation or solar protection device, without having to disassemble a screen of the occultation or solar protection device or the rail.

To this end, according to a first aspect, the present invention is directed at a motorized drive device of an occultation or solar protection device, the motorized drive device being provided for moving at least one screen in a sliding movement along a rail, the motorized drive device comprising at least:
an electric motor,
a drive wheel, the drive wheel being configured to be rotated by the electric motor and to be brought into contact with at least one running surface of the rail, so as to move the motorized drive device along the rail in a direction of movement,
a first holding device, the first holding device comprising at least a first and a second guide wheels, the first and second guide wheels being configured to be inserted into or extracted from the rail, through a slot of the rail, and to be brought into contact with at least a respective first and second tracks of the rail, so as to hold or release the motorized drive device relative to the rail, and
a first switching mechanism, the first switching mechanism being configured to drive at least the first guide wheel of the first holding device between a first position and a second position, and vice versa.

According to the invention, in a first position of the first switching mechanism, the first guide wheel of the first holding device is offset from the second guide wheel of the first holding device, so as to hold the motorized drive device relative to the rail by supporting the first and second guide wheels with the respective first and second tracks of the rail. Furthermore, in a second position of the first switching mechanism, the first guide wheel of the first holding device is positioned opposite the second guide wheel of the first holding device, in the direction of movement of the motorized drive device along the rail, so as to insert or extract the first and second guide wheels into or from the rail, through the slot of the rail.

Thus, offsetting the first guide wheel of the first holding device relative to the second guide wheel of the first holding device makes it possible to guarantee that the motorized drive device is held relative to the rail and, more particularly, supporting the first and second guide wheels with the respective first and second tracks of the rail. Furthermore, the alignment of the first guide wheel of the first holding device relative to the second guide wheel of the first holding device makes it possible to insert or extract the first and second guide wheels into or from the rail, through the slot of the rail.

In this manner, offsetting the first and second guide wheels of the first holding device, in the first position of the first switching mechanism, makes it possible to guarantee the movement of the motorized drive device along the rail, by means of the drive wheel and the electric motor. Furthermore, the alignment of the first and second guide wheels of the first holding device, in the second position of the first switching mechanism, makes it possible to facilitate easy insertion or extraction of the first and second guide wheels relative to the rail, without having to disassemble a screen from the occultation device or the rail.

According to an advantageous feature of the invention, the first guide wheel of the first holding device is movable relative to the second guide wheel of the first holding device. Furthermore, a movement of the first guide wheel of the first holding device relative to the second guide wheel of the first holding device is implemented by the first switching mechanism.

According to another advantageous feature of the invention, the second guide wheel of the first holding device is fixed relative to a housing of the motorized drive device.

According to another advantageous feature of the invention, the first holding device further comprises at least a first and a second arm, the first arm being connected to the first guide wheel, on the one hand, and to the first switching mechanism, on the other hand, the second arm being connected to the second guide wheel, on the one hand, and to the housing, on the other hand.

According to another advantageous feature of the invention, the first switching mechanism further comprises at least a first button. Furthermore, the first button is configured to actuate the first switching mechanism, so as to drive the first guide wheel of the first holding device relative to the second guide wheel of the first holding device, between its first position and its second position.

According to another advantageous feature of the invention, the motorized drive device further comprises at least one elastic return element. Furthermore, the elastic return element is configured to tilt the first switching mechanism to an initial position, so as to drive the first guide wheel of the first holding device relative to the second guide wheel of the first holding device, between its second position and its first position.

According to another advantageous feature of the invention, the motorized drive device further comprises:
a second holding device, the second holding device comprising at least a first and a second guide wheels, the first and second guide wheels being configured to be inserted into or extracted from the rail, through the slot in the rail, and to be brought into contact with at least the respective first and second rolling tracks of the rail, so as to hold or release the motorized drive device relative to the rail,
a second switching mechanism, the second switching mechanism being configured to drive at least the first guide wheel of the second holding device between a first position and a second position, and vice versa.

In the first position of the second switching mechanism, the first guide wheel of the second holding device is offset relative to the second guide wheel of the second holding device, so as to hold the motorized drive device relative to the rail by supporting the first and second guide wheels with the respective first and second tracks of the rail. Furthermore, in the second position of the second switching mechanism, the first guide wheel of the second holding device is positioned opposite the second guide wheel of the second holding device, in the direction of movement of the motorized drive device along the rail, so as to insert or extract the first and second guide wheels into or from the rail, through the slot of the rail.

According to a second aspect, the present invention is directed at an occultation or solar protection device comprising at least:
a screen,
a rail, and
a motorized drive device according to the invention and as mentioned above, the screen being suspended from the rail and being movable along the rail, by means of the motorized drive device.

This occultation or solar protection device has similar features and advantages as described above, in relation to the motorized drive device according to the invention.

According to an advantageous feature of the invention, the first and second guide wheels of the first holding device have a respective diameter greater than a width of the slot of the rail.

According to another advantageous feature of the invention, the first arm and the first guide wheel of the first holding device have a first cumulative thickness, in an assembled configuration of the motorized drive device. The second arm and the second guide wheel of the first holding device have a second cumulative thickness, in the assembled configuration of the motorized drive device. Furthermore, the first cumulative thickness of the first arm and the first guide wheel and the second cumulative thickness of the second arm and the second guide wheel are respectively less than a width of the slot of the rail.

According to a third aspect, the present invention is directed at a home automation installation comprising an occultation or solar protection device according to the invention, as mentioned above.

This home automation installation has features and advantages similar to those described above, in relation to the occultation or solar protection device according to the invention.

Further features and advantages of the invention will become apparent from the description below.

### BRIEF DESCRIPTION OF THE DRAWINGS

In the appended drawings, given as non-limiting examples:

FIG. 1 is a schematic perspective view of a part of a curtain comprising a motorized drive device according to one embodiment of the invention;

FIG. 2 is a schematic perspective view of the motorized drive device, illustrated in FIG. 1;

FIG. 3 is a first schematic side view of the motorized drive device, illustrated in FIGS. 1 and 2, showing a first guide wheel of a first holding device offset from a second guide wheel of the first holding device;

FIG. 4 is a second schematic side view of the motorized drive device, similar to FIG. 3, showing the second guide wheel of the first holding device positioned opposite the first guide wheel of the first holding device;

FIG. 5 is a schematic side view illustrating the assembly of the motorized drive device, illustrated in FIGS. 1 to 4, relative to a rail, where the first and second guide wheels of the first holding device are accommodated in the rail and brought into contact, respectively, on a rolling track of the rail;

FIG. 6 is a schematic exploded perspective view of the motorized drive device, illustrated in FIGS. 1 to 5;

FIG. 7 is a schematic perspective view of the motorized drive device, illustrated in FIGS. 1 to 6, where a housing has been omitted;

FIG. 8 is an exploded schematic perspective view of a part of the motorized drive device, illustrated in FIGS. 1 to 7, comprising a drive unit and an electronic control unit;

FIG. 9 is an exploded schematic perspective view of a part of the motorized drive device, illustrated in FIGS. 1 to 7, comprising a chassis, a first holding device and a second holding device;

FIG. 10 is a schematic front view of the motorized drive device, illustrated in FIGS. 1-9, where the housing has been omitted, this view showing a first and second switching devices in a first position;

FIG. 11 is a schematic front view of the motorized drive device, illustrated in FIGS. 1-9, similar to FIG. 10, showing the first and second switching devices in a second position, different from the first position.

### DESCRIPTION OF THE PREFERRED EMBODIMENTS

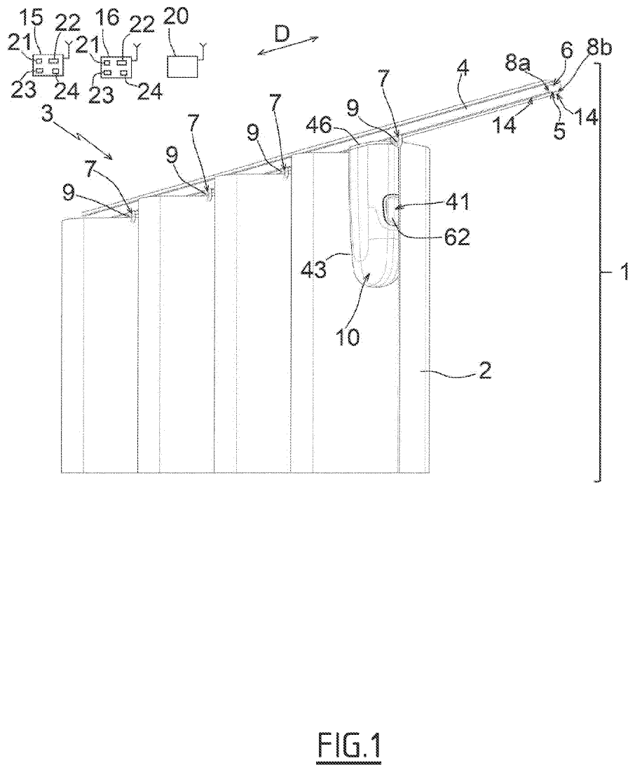

First, with reference to FIG. 1, a home automation installation 1 according to the invention is described, installed in a building comprising an opening, not shown, in which a window or a door is arranged, equipped with at least one screen 2 belonging to an occultation or solar protection device 3, in particular a motorized curtain.

The occultation or solar protection device 3 is hereinafter referred to as an “occultation device”. The occultation device 3 comprises the screen 2, which is formed by a curtain, in the example of the Figures.

In a variant, the screen 2 can be formed by a blackout canvas, a curtain or even slats.

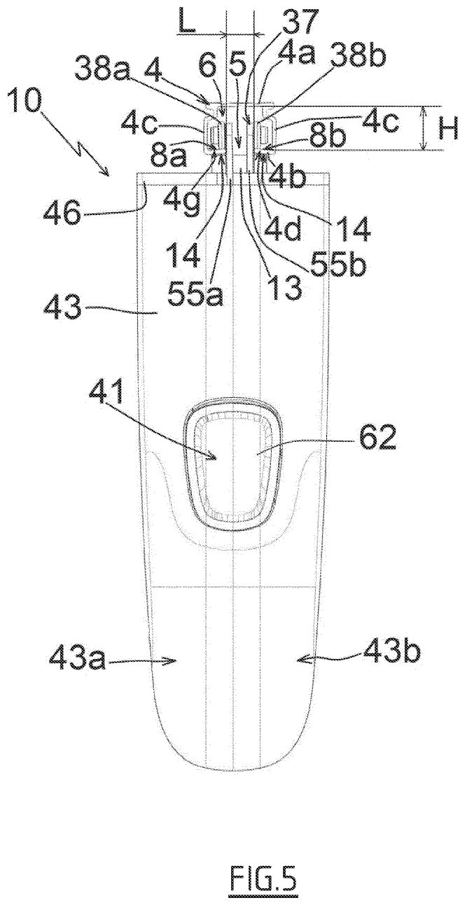

The occultation device 3 further comprises at least one rail 4. The rail 4 comprises at least one slot 5, as illustrated in FIGS. 1 and 5.

Here and as illustrated in FIG. 5, the rail 4 comprises a top wall 4a, a bottom wall 4b and two side walls 4c. The bottom wall 4b of the rail 4 comprises the slot 5. The bottom wall 4b of the rail 4 comprises a first portion 4g and a second portion 4d, provided on either side of the slot 5.

Here, the rail 4 has a square cross section.

The section of the rail is not restrictive and can be different. It can be rectangular, for example.

Advantageously, the slot 5 of the rail 4 extends in a longitudinal direction of the rail 4.

Advantageously, the bottom wall 4b of the rail 4 comprises an inner face and an outer face.

Advantageously, the rail 4 further comprises a recess 6.

Here, the recess 6 of the rail 4 is formed between the top wall 4a, bottom wall 4b and side walls 4c of the rail 4.

Advantageously, the rail 4 is configured to be fixed, in other words is fixed, to a ceiling of a room in the building, in an assembled configuration of the installation 1.

Here, the occultation device 3 comprises a single screen 2 that can be moved along the rail 4. The screen 2 is suspended from the rail 4.

In a variant, not shown, the occultation device 3 comprises two screens 2. The two screens 2 can be moved along the same rail 4 or along two separate rails parallel to each other. In the case where two screens 2 can be moved along the same rail 4, they are each arranged near one end of the rail 4.

Advantageously, the occultation device 3 further comprises support elements 7 of the screen 2. The support elements 7 are configured to retain the screen 2 relative to the rail 4 and to move the screen 2 along the rail 4, in an assembled configuration of the occultation device 3.

The rail 4 further comprises at least a first rolling track 8a and at least a second rolling track 8b.

Advantageously, the first and second rolling tracks 8a, 8b of the rail 4 are provided on either side of the slot 5 of the rail 4.

Advantageously, the first and second rolling tracks 8a, 8b of the rail 4 are formed by the inner face of the bottom wall 4b of the rail 4 and, more particularly, by the inner face of the first and second portions 4g, 4d of the bottom wall 4b of the rail 4.

Advantageously, each support element 7 comprises a first and a second wheel, not shown. The first and second wheels of a support 7 are configured to be brought into contact with the respective first and second rolling tracks 8a, 8b of the rail 4, in the assembled configuration of the occultation device 3.

Advantageously, each support element 7 further comprises a hook 9. The hook 9 is configured to suspend the screen 2 relative to the rail 4, in the assembled configuration of the occultation device 3. Furthermore, the hook 9 is configured to extend through the slot 5 of the rail 4, in the assembled configuration of the occultation device 3.

The first and second wheels of each support element 7 are configured to be free to rotate, about an axis of rotation.

Advantageously, the axis of rotation of the first and second wheels of each support element 7 is orthogonal to a direction of movement D of the screen 2 along the rail 4.

The occultation device 3 further comprises at least one motorized drive device 10. The motorized drive device 10 is configured to be held on the rail 4, in other words suspended from the rail 4, in the assembled configuration of the occultation device 3, and to move along the rail 4, so as to close or open the screen 2. The motorized drive device 10 is provided, in other words is configured, to move the screen 2 along the rail 4 in a sliding movement.

Here, the rail 4 is a guide support of the motorized drive device 10.

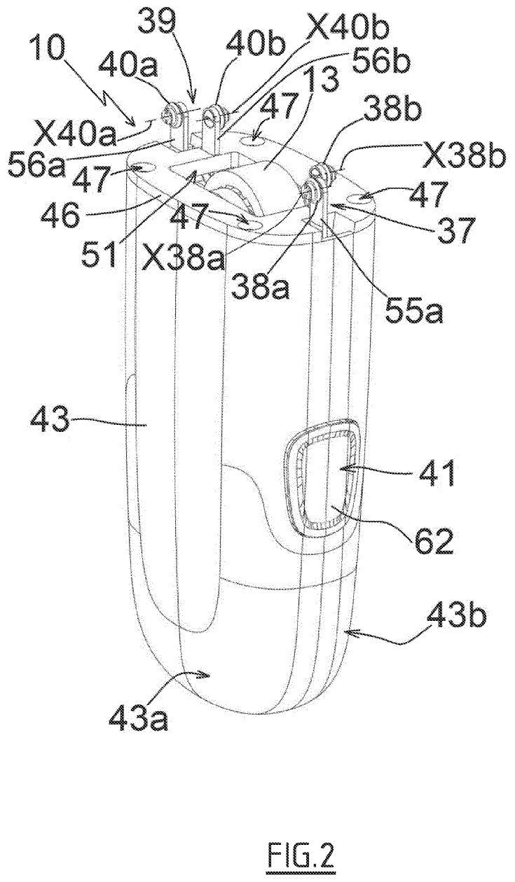

The motorized drive device 10 of the occultation device 3 illustrated in FIG. 1 is now described with reference to FIGS. 2 to 11.

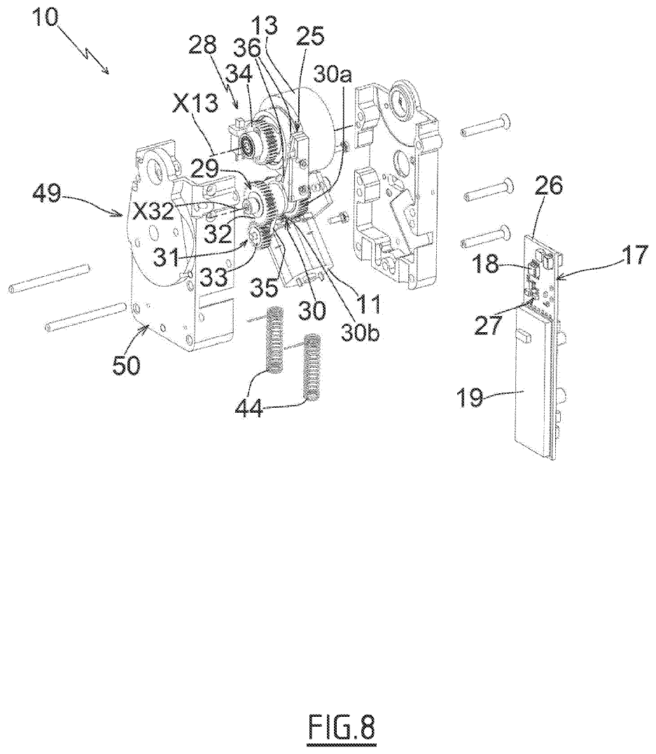

The motorized drive device 10 comprises an electric motor 11, as illustrated in FIG. 8.

The electric motor 11 is supplied with electrical power by means of an electrical power source.

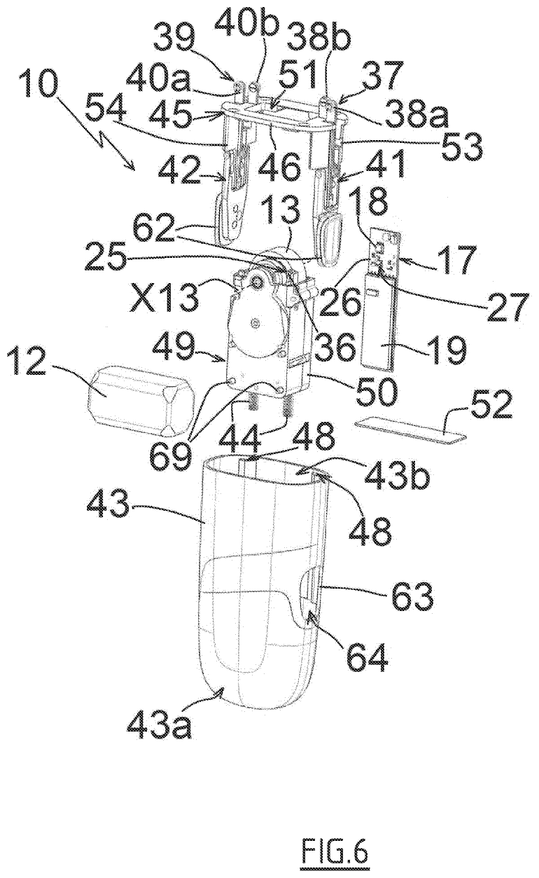

Advantageously, the electric power source can be a battery 12, for example, of the rechargeable type, in other words as an accumulator, as illustrated in FIGS. 6, 7, 10 and 11, or of the non-rechargeable type, in other words as one or more cells.

Here, the electric motor 11 is of the brushless direct current type, also known as “BLDC”, or “permanent magnet synchronous”, or DC type.

Each support element 7 is configured to be moved along the rail 4, upon electrical activation of the electric motor 11 of the motorized drive device 10, so as to close or open the screen 2.

Advantageously, the motorized drive device 10 is configured to allow the screen 2 to be moved manually, in the event that the battery 12 has a state of charge below a threshold value.

The motorized drive device 10 further comprises a drive wheel 13.

The rail 4 further comprises at least one running surface 14, as illustrated in FIGS. 1 and 5.

The drive wheel 13 is configured to be rotated by means of the electric motor 11, in particular about an axis of rotation X13, and to be brought into contact with the running surface 14 of the rail 4, so as to move the motorized drive device 10 along the rail 4.

Thus, the running surface 14 of the rail 4 is configured to interact, in other words interacts, with the drive wheel 13, in the assembled configuration of the occultation device 3.

Advantageously, the running surface 14 of the rail 4 is formed by the outer side of the bottom wall 4b of the rail 4 and, more particularly, by the outer side of the first and second parts 4g, 4d of the bottom wall 4b of the rail 4.

Here, the running surface 14 of the rail 4 is thus formed by two treads located on either side of the slot 5 of the rail 4.

In a variant, not shown, the running surface 14 of the rail 4 can be formed by a single tread located on either side of the slot 5 of the rail 4.

Here, the motorized drive device 10 is configured to move along the rail 4 in a direction of movement. The direction of movement of the motorized drive device 10 relative to the rail 4 corresponds to the longitudinal direction of the rail 4. Furthermore, the direction of movement of the motorized drive device 10 relative to the rail 4 is identical to the direction of movement D of the screen 2 along the rail 4.

Advantageously, the axis of rotation X13 of the drive wheel 13 is orthogonal to the direction of movement D of the motorized drive device 10 along the rail 4.

Advantageously, the motorized drive device 10 is controlled by a control unit 15, 16. The control unit can be, for example, a local control unit 15 or a central control unit 16, as illustrated in FIG. 1.

Advantageously, the local control unit 15 can be connected to the central control unit 16, in a wired manner or wirelessly.

Advantageously, the central control unit 16 can control the local control unit 15, as well as other similar local control units distributed throughout the building.

The motorized drive device 10 is, preferably, configured to execute commands for closing or opening the screen 2 of the occultation device 3, which can be emitted by the local control unit 15 or the central control unit 16, in particular.

The installation 1 comprises either the local control unit 15, the central control unit 16, or the local control unit 15 and the central control unit 16.

Means for controlling the motorized drive device 10, enabling movement of the screen 2 of the occultation device 3, comprise at least one electronic control unit 17, as illustrated in FIGS. 6 and 8. This electronic control unit 17 is capable of making the electric motor 11 operate and of enabling the electric power supply to the electric motor 11, in particular. This electronic control unit 17 can further be capable of regulating a rotational speed of the electric motor 11, as well as modifying the rotational speed of the electric motor 11, in particular increasing this rotational speed when the electric motor 11 is started or decreasing this rotational speed when the electric motor 11 is stopped.

Thus, the electronic control unit 17 controls the electric motor 11, in particular, so as to close or open the screen 2.

The means for controlling of the motorized drive device 10 comprise hardware and/or software means. As a non-limiting example, the hardware means can comprise at least one microcontroller 18.

Advantageously, the electronic control unit 17 comprises a first communication module 19, as illustrated in FIG. 8, in particular for receiving command orders, the command orders being emitted by an order emitter, such as the local control unit 15 or the central control unit 16, these orders being intended to control the motorized drive device 10.

Preferably, the first communication module 19 of the electronic control unit 17 is of a wireless type. In particular, the first communication module 19 is configured to receive radio command orders.

Advantageously, the electronic control unit 17, the local control unit 15 and/or the central control unit 16 can communicate with one or more sensors, not shown, arranged inside the building or left outside the building. This or these sensors can be configured to determine temperature, luminosity or humidity, for example.

Advantageously, the electronic control unit 17, the local control unit 15 and/or the central control unit 16 can also communicate with a server 20, as illustrated in FIG. 1, so as to control the motorized drive device 10 based on to data made available remotely by means of a communication network, in particular an internet network that can be connected to the server 20.

The electronic control unit 17 can be controlled from the local control unit 15 or central control unit 16. The local control unit 15 or central control unit 16 is provided with a control keyboard. The control keyboard of the local control unit 15 or central control unit 16 comprises one or more selection elements 21 and, eventually, one or more display elements 22.

By way of non-limiting examples, the selection elements can include push buttons and/or touch sensitive keys. The display elements can include light-emitting diodes and/or a liquid crystal display (LCD) or a thin film transistor (TFT) display. The selection and display elements can also be made by means of a touch screen.

The local control unit 15 or central control unit 16 comprises at least a second communication module 23.

Thus, the second communication module 23 of the local control unit 15 or central control unit 16 is configured to transmit, in other words transmit, command orders, in particular by wireless means, for example radio, or by wired means.

Furthermore, the second communication module 23 of the local control unit 15 or central control unit 16 can also be configured to receive, in other words receive, command orders, in particular via the same means.

The second communication module 23 of the local control unit 15 or central control unit 16 is configured to communicate, in other words communicate, with the first communication module 19 of the electronic control unit 17.

Thus, the second communication module 23 of the local control unit 15 or central control unit 16 exchanges command orders with the first communication module 19 of the electronic control unit 17, either mono- or bi-directionally.

Advantageously, the local control unit 15 is a control point, which can be fixed or nomadic. A fixed control point can be a control box intended to be fixed on a façade of a building wall or on a face of a window or door frame. A nomadic control point can be a remote control, a smartphone or a tablet.

Advantageously, the local control unit 15 or central control unit 16 also includes a controller 24.

The motorized drive device 10, in particular the electronic control unit 17, is, preferably, configured to execute movement command orders, in particular for closing as well as opening, of the screen 2 of the occultation device 3. These command orders can be emitted by the local control unit 15 or the central control unit 16, in particular.

The motorized drive device 10 can be controlled by the user, for example, by receiving a command order corresponding to pressing the or one of the selection elements 21 of the local control unit 15 or central control unit 16.

The motorized drive device 10 can also be controlled automatically, for example, by receiving a command order corresponding to at least one signal from at least one sensor and/or a signal from a clock of the electronic control unit 17, in particular the microcontroller 18. The sensor and/or the clock can be integrated in the local control unit 15 or in the central control unit 16.

Advantageously, the motorized drive device and, more particularly, the electronic control unit 17 is configured to electrically activate the electric motor 11, following a detection of a movement of the screen 2 implemented manually, in particular by the user.

Thus, the movement of the screen 2 is implemented, in a first step, manually and, in a second step, automatically by means of the motorized drive device 10.

In this way, the movement of the screen 2 is started manually and then continued automatically by the motorized drive device 10.

Here, the detection of a manual movement of the screen 2 is implemented by the electronic control unit 17 and by means of a counting device 25, in particular, as illustrated in FIGS. 5 and 8.

Advantageously, the electronic control unit 17 is configured to determine a direction of movement of the screen 2 implemented manually, so as to control the electric motor 11 based on the direction of movement determined.

Here, detection of the movement direction of the screen 2 is implemented by the electronic control unit 17 and, in particular, by means of the counting device 25.

Here, the electronic control unit 17 comprises a first electronic board 26, configured to drive the electric motor 11, and a second electronic board, not shown, equipped with the first communication module 19, configured to receive command orders and, eventually, to transmit messages.

In a variant, not shown, the electronic control unit 17 comprises a single electronic board 26, equipped with the first communication module 19, configured to drive the electric motor 11 and to receive command orders and, eventually, to transmit messages.

Advantageously, the electronic control unit 17 comprises a device 27 for measuring an intensity value I of an electric current flowing through the electric motor 11.

Thus, the measuring device 27 can learn end-of-travel positions, closed or open, of the screen 2 and detect one of these end-of-travel positions being reached, during electric activation of the electric motor 11.

Advantageously, the motorized drive device 10 further comprises a transmission device 28, as illustrated in FIG. 8. The transmission device 28 is configured to be connected, in other words is connected, to the electric motor 11, in an assembled configuration of the motorized drive device 10. Furthermore, the transmission device 28 is configured to drive the drive wheel 13, upon electrical activation of the electric motor 11.

Advantageously, the transmission device 28 comprises a gearbox 29.

Here, the gearbox 29 comprises two reduction stages. A first reduction stage of the gearbox 29 is formed by a wheel and worm system 30. A second reduction stage of the gearbox 29 is formed by a gear system 31 comprising an input gear 32, a satellite 33 and an output gear 34. A wheel 30a of the wheel and worm system 30 is meshed with a screw 30b of the wheel and worm system 30. The satellite 33 is mounted on a pivoting arm 35. The wheel 30a of the wheel and worm system 30 is integral with the input gear 32 and, more particularly, the wheel 30a and the input gear 32 have a common axis of rotation X32. The pivoting arm 35 is connected to the input gear 32. The satellite 33 is configured to be meshed with the output gear 34, depending on an angular orientation of the pivoting arm 35 relative to the input gear 32. Furthermore, the output gear 34 is integral with the drive wheel 13.

The type and number of reduction stages of the gearbox are not limiting and can be different.

Advantageously, when a command to stop the electric motor 11 is executed by the electronic control unit 17, a drive of the electric motor 11 in a direction of rotation opposite, to the initial direction of rotation of the electric motor 11, is implemented, so as to disengage the gearbox 29, in particular the second reduction stage.

Here, disengagement of the gearbox 29 is implemented by a backward movement of the pivoting arm 35 so as to disengage the satellite 33 relative to the output gear 34.

Thus, following disengagement of the gearbox 29, in particular of the second reduction stage of the gearbox 29, the motorized drive device 10 and, more particularly, the screen 2 can be moved manually relative to the rail 4.

Advantageously, the motorized drive device 10 comprises the counting device 25. Furthermore, the counting device 25 is configured to interact with the electronic control unit 17.

Advantageously, the counting device 25 comprises at least one sensor 36, in particular a position sensor.

Here and as illustrated in FIGS. 6 and 8, the counting device 25 comprises two sensors 36, only one of which is visible in FIG. 6.

The number of sensors of the counting device is not limiting and can be different, in particular equal to one or greater than or equal to three.

In one example embodiment, the counting device 25 is of the magnetic type, for example an encoder equipped with one or more Hall effect sensors.

Here, the counting device 25 is used to determine the angular position of the drive wheel 13.

In a variant, the counting device 25 is used to determine the number of revolutions made by a rotor of the electric motor 11, from a reference position.

The type of counting device 25 is not limiting and can be different. In particular, this counting device can be of the optical type, for example an encoder equipped with one or more optical sensors, or of the temporal type, for example a clock of the microcontroller.

Thus, the counting device 25 can enable detection of one of the end-of-travel positions being reached.

In a variant, the motorized drive device 10 can comprise a first counting device 25 provided with one or more sensors 36 and a second counting device of time-based type, not shown, implemented by means of a clock of the microcontroller 18, for example.

Thus, the first counting device 25 can enable detection of reaching one of the end-of-travel positions and the second counting device can enable determination of intermediate positions between the two end-of-travel positions, so as to minimize an electric power consumption of the motorized drive device 10 and to increase an operating time of the battery 12.

Advantageously, the electronic control unit 17, in particular the microcontroller 18, is configured to determine the disengagement of the gearbox 29, in particular of the second reduction stage of the gearbox 29, by means of the counting device 25, in particular by means of one or more signals transmitted by the counting device 25 to the electronic control unit 17.

The disengagement of the gearbox 29, in particular of the second reduction stage, following a command to stop the electric motor 11, can thus make it possible to start the electric motor 11 automatically, following detection of movement of the screen 2 implemented manually, in particular by means of the counting device 25, so as to move the screen 2 relative to the rail 4.

Disengagement of the gearbox 29, in particular of the second reduction stage of the gearbox 29, following a command to stop the electric motor 11, can further make it possible to close or open the screen 2 manually, in the event that the battery 12 is discharged, in other words has a state of charge below a predetermined threshold value.

The motorized drive device 10 further comprises a first holding device 37. The first holding device 37 comprises at least a first guide wheel 38a and a second guide wheel 38b. The first and second guide wheels 38a, 38b are configured to be inserted into or extracted from the rail 4, through the slot 5 of the rail 4, and to be brought into contact with the respective first and second rolling tracks 8a, 8b of the rail 4, so as to hold or release the motorized drive device 10 relative to the rail 4.

In a variant, not shown, the first holding device 37 can comprise two or more pairs of guide wheels 38a, 38b.

Here and preferably, the motorized drive device 10 further comprises a second holding device 39. The second holding device 39 comprises at least a first guide wheel 40a and a second guide wheel 40b. The first and second guide wheels 40a, 40b are configured to be inserted into or extracted from the rail 4, through the slot 5 of the rail 4, and to be brought into contact with at least the respective first and second rolling tracks 8a, 8b of the rail 4, so as to hold or release the motorized drive device 10 relative to the rail 4.

In a variant, not shown, the second holding device 39 can comprise two or more pairs of guide wheels 40a, 40b.

Thus, in the example embodiment illustrated in FIGS. 2 through 11, the motorized drive device 10 comprises the first holding device 37 and the second holding device 39. The first holding device 37 comprises at least a first pair of guide wheels 38a, 38b and the second holding device 39 comprises at least a second pair of guide wheels 40a, 40b. Furthermore, each of the first and second rolling tracks 8a, 8b of the rail 4 is configured to interact, in other words interacts, with one of the guide wheels 38a, 38b, 40a, 40b of each of the first and second holding devices 37, 39, in the assembled configuration of the occultation device 3.

In this manner, the first pair of guide wheels 38a, 38b is configured to be inserted into the rail 4, through the slot 5 of the rail 4, and to be brought into contact with the first and second rolling tracks 8a, 8b of the rail 4, so as to hold the motorized drive device 10 relative to the rail 4. Furthermore, the second pair of guide wheels 40a, 40b is configured to be inserted into the rail 4, through the slot 5 of the rail 4, and to be brought into contact with the first and second rolling tracks 8a, 8b of the rail 4, so as to hold the motorized drive device 10 relative to the rail 4.

The first and second guide wheels 38a, 38b, 40a, 40b of the respective first holding device 37 or second holding device 39, are configured to be free to rotate, in particular about an axis of rotation X38a, X38b, X40a, X40b, as illustrated in FIG. 2.

Advantageously, the first and second guide wheels 38a, 38b, 40a, 40b of the respective first holding device 37 or second holding device 39 are configured to be accommodated, in other words are accommodated, inside the recess 6 of the rail 4, in the assembled configuration of the occultation device 3.

Advantageously, the first and second holding devices 37, 39 are configured to be arranged, in other words are arranged, on either side of the axis of rotation X13 of the drive wheel 13, in the direction of movement D of the motorized drive device 10 along the rail 4, in the assembled configuration of the motorized drive device 10.

Advantageously, the axis of rotation X38a, X38b, X40a, X40b of the first and second guide wheels 38a, 38b, 40a, 40b of the respective first holding device 37 or second holding device 39 is orthogonal to the direction of movement D of the motorized drive device 10 along the rail 4.

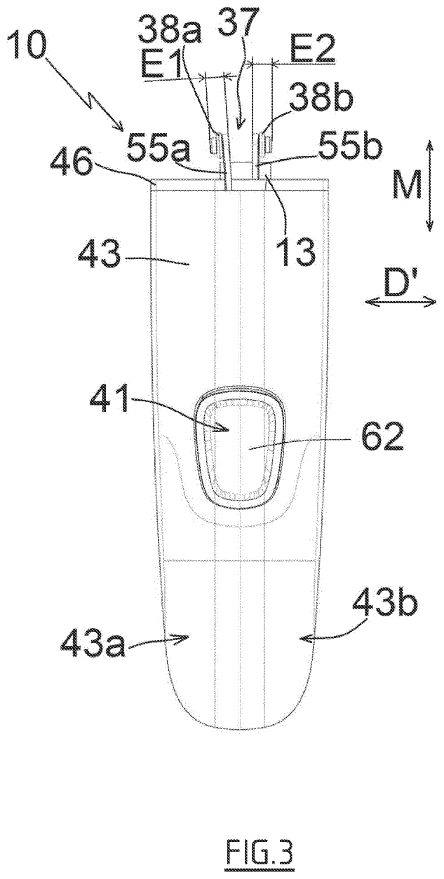

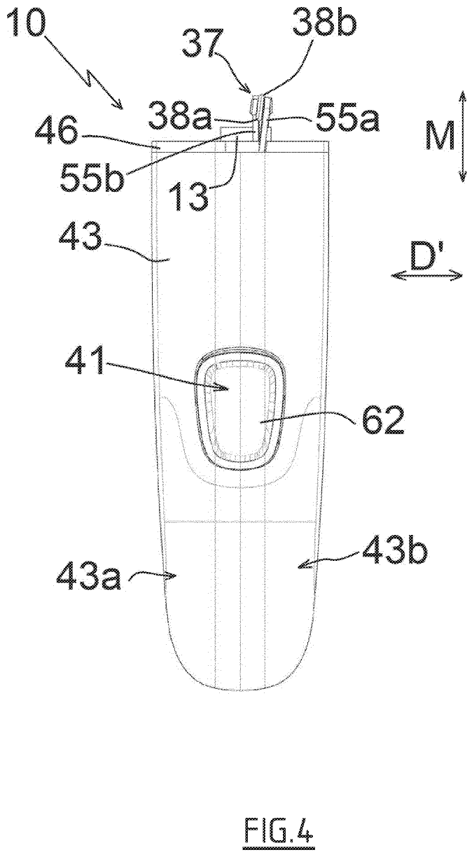

The motorized drive device 10 further comprises a first switching mechanism 41. The first switching mechanism 41 is configured to drive the first guide wheel 38a of the first holding device 37 between a first position, as illustrated in FIG. 3, and a second position, as illustrated in FIG. 4, and vice versa, in particular relative to the second guide wheel 38b of the first holding device 37.

Advantageously, the motorized drive device 10 further comprises a second switching mechanism 42. The second switching mechanism 42 is configured to drive the first guide wheel 40a of the second holding device 39 between a first position and a second position, and vice versa, in particular relative to the second guide wheel 40b of the second holding device 39.

The first position of the first guide wheel 38a, 40a of the respective first holding device 37 or second holding device 39 is a position in which the first and second guide wheels 38a, 38b, 40a, 40b are configured to be brought into contact with at least one of the first and second rolling tracks 8a, 8b of the rail 4, respectively.

The second position of the first guide wheel 38a, 40a of the respective first holding device 37 or the second holding device 39 is a position in which the first and second guide wheels 38a, 38b, 40a, 40b are configured to be inserted into or extracted from the rail 4, through the slot 5 of the rail 4.

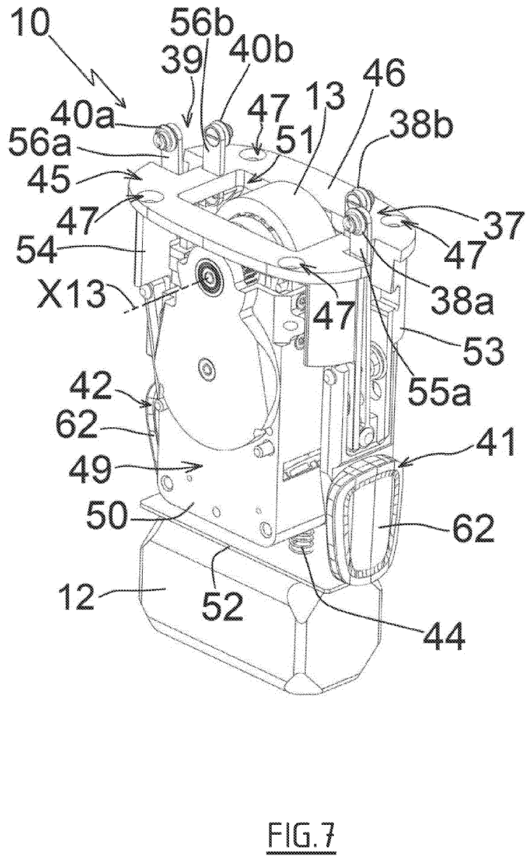

Advantageously, the motorized drive device 10 further comprises at least one housing 43, which is not illustrated in FIGS. 7 and following.

Advantageously, the housing 43 comprises a first half-shell 43a and a second half-shell 43b. Furthermore, the first and second half-shells 43a, 43b are configured to be assembled, in other words are assembled, together, by means of fastening elements, not shown, in the assembled configuration of the motorized drive device 10.

Here, the fastening elements of the housing 43 are elastic snap-in fastening elements.

The fastener type is not limiting and can be different. It can be screw-fastening elements, for example.

Advantageously, one of the first and second half-shells 43a, 43b is a hatch, so as to allow access to the battery 12, in particular to replace the latter.

Advantageously, the motorized drive device 10 further comprises at least a first elastic return element 44. The or each first elastic return element 44 is configured to press the drive wheel 13 against the running surface 14 of the rail 4, in the assembled configuration of the occultation device 3 and, more particularly, in the first position of the first and second switching mechanisms 41, 42.

Here, the motorized drive device 10 comprises two first elastic return elements 44. Furthermore, each first elastic return element 44 is a spring, a compression spring in particular, and is formed as a spiral.

The number and shape of the first elastic return elements are not limiting and can be different. The number of first elastic return elements can be one, three or more. Furthermore, the or each first elastic return element can be a tension spring and can be made as a pin or can be a leaf spring.

Advantageously, the drive wheel 13 is movable, in particular in a translational movement M, as illustrated in FIGS. 3, 4 and 10 and 11, inside the housing 43, so as to be brought into contact against the running surface 14 of the rail 4, by means of the first elastic return elements 44, in the assembled configuration of the occultation device 3 and, more particularly, in the first position of the first and second switching mechanisms 41, 42.

Advantageously, the motorized drive device 10 comprises a chassis 45. Furthermore, the chassis 45 is configured to interact, in other words interacts, with the respective first holding device 37 or second holding device 39, in the assembled configuration of the motorized drive device 10.

Advantageously, the chassis 45 comprises a wall 46, in particular a top wall.

Here, the wall 46 of the chassis 45 is a closure wall of the housing 43.

Advantageously, in the assembled configuration of the occultation device 3, the wall 46 of the chassis 45 is parallel to the running surface 14 of the rail 4.

Advantageously, the chassis 45 is configured to interact, in other words interacts, with the respective first switching mechanism 41 or second switching mechanism 42, in the assembled configuration of the motorized drive device 10.

Advantageously, the chassis 45 is integral with the housing 43.

Here, in the assembled configuration of the motorized drive device 10, the chassis 45, in particular the wall 46 of the chassis 45, is fixed to the housing 43, by means of fixing elements, not shown.

Here, the fixing elements of the chassis 45 relative to the housing 43 are fastening screws, four in number, and are not shown. Each fastening screw is placed through a through-hole 47 in the wall 46 of the chassis 45 and is screwed into a fastening hole 48 of the housing 43, in the assembled configuration of the motorized drive device 10. Only two of the fastening holes 48 of the housing 43 are shown in FIG. 6.

The number and type of fixing elements are not limiting and can be different. The number of fixing elements can be two, three, five or more, for example. Furthermore, the type of fixing elements can be snap-in elastic, for example.

Advantageously, the motorized drive device 10 comprises a drive unit 49. The drive unit 49 is configured to be housed, in other words is housed, within the housing 43, in the assembled configuration of the motorized drive device 10.

Advantageously, the drive unit 49 comprises a housing 50.

Advantageously, the drive unit 49 further comprises at least the electric motor 11, the drive wheel 13 and, eventually, the transmission device 28.

Advantageously, the electric motor 11 and, eventually, the transmission device 28 are configured to be housed, in other words are housed, within the housing 50 of the drive unit 49 and, as a result, within the housing 43, in the assembled configuration of the motorized drive device 10.

Advantageously, the drive wheel 13 is configured to be housed, in other words is housed, partially within the housing 50 of the drive unit 49 and is configured to be placed, in other words is placed, partially outside of the housing 50 of the drive unit 49, in the assembled configuration of the motorized drive device 10.

Here, the drive wheel 13 is configured to be housed, in other words is housed at least partially within the housing 43, or even completely, in the second position of the first and second switching mechanisms 41, 42. Furthermore, the drive wheel 13 is configured to be placed, in other words is placed, partially outside the housing 43, in the first position of the first and second switching mechanisms 41, 42.

Advantageously, the drive wheel 13 is configured to be placed, in other words is placed, in the central part of the wall 46 of the chassis 45 and, more particularly, through a central opening 51 of the wall 46 of the chassis 45, in the assembled configuration of the motorized drive device 10.

Advantageously, the first elastic return elements 44 are configured to interact, on the one hand, with the housing 43 of the motorized drive device 10 and, on the other hand, with the housing 50 of the drive unit 49.

Thus, the drive unit 49 is movable, in particular along the translational movement M, within the housing 43, by means of the first elastic return elements 44, so as to bring into contact the drive wheel 13 with the running surface 14 of the rail 4, in the assembled configuration of the occultation device 3 and, more particularly, in the first position of the first and second switching mechanisms 41, 42.

Here, the first elastic return elements 44 are configured to interact, on the one hand, with a support wall 52 arranged in the lower part of the housing 43 of the motorized drive device 10 and, on the other hand, with the housing 50 of the drive unit 49.

Advantageously, in the assembled configuration of the occultation device 3, the support wall 52 is parallel to the running surface 14 of the rail 4.

In this example embodiment, the support wall 52 is removable and is brought into contact against the housing 43, in particular at an area of a bottom region of the housing 43.

In the assembled configuration of the occultation device 3 and, more particularly, in the first position of the first and second switching mechanisms 41, 42, the first elastic return elements 44 make it possible to take into consideration a change in a mass of the screen 2 to be pulled or pushed by means of the motorized drive device 10, during movement of the motorized drive device 10 along the rail 4 by the electric activation of the electric motor 11, both for closing the screen 2 and for opening the screen 2, by adjusting a pressure exerted by the drive wheel 13 on the running surface 14 of the rail 4.

Advantageously, the first and second guide wheels 38a, 38b, 40a, 40b of the respective first holding device 37 or second holding device 39 are configured to be arranged, in other words are arranged, outside the housing 43, in the assembled configuration of the motorized drive device 10.

Advantageously, the first and second holding devices 37, 39 are identical.

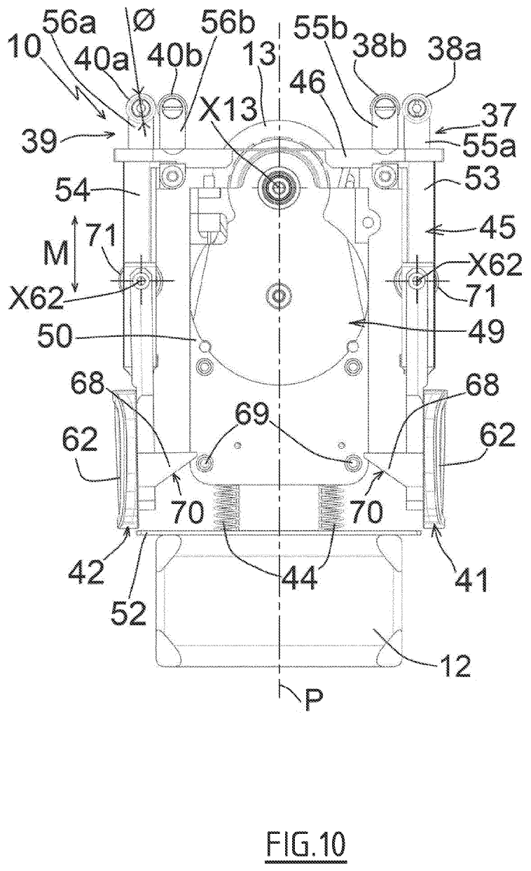

Advantageously, the first and second holding devices 37, 39 are configured to be arranged, in other words are arranged, symmetrically relative to a median plane P of the motorized drive device 10 and, more particularly, of the housing 43, with the trace of this median plane P illustrated in FIG. 10.

Here, as visible in FIG. 2, in the first position of the respective first switching mechanism 41 or second switching mechanism 42, the first and second guide wheels 38a, 38b, 40a, 40b of the respective first holding device 37 or second holding device 39 are arranged in a staggered arrangement.

In a first position of the respective first switching mechanism 41 or second switching mechanism 42, the first guide wheel 38a, 40a of the respective first holding device 37 or second holding device 39 is staggered relative to the second guide wheel 38b, 40b of the respective first holding device 37 or second holding device 39, so as to hold the motorized drive device 10 relative to the rail 4 by bringing into contact the first and second guide wheels 38a, 38b, 40a, 40b respectively with the first and second rolling tracks 8a, 8b of the rail 4. Furthermore, in a second position of the respective first switching mechanism 41 or second switching mechanism 42, the first guide wheel 38a, 40a of the respective first holding device 37 or second holding device 39 is positioned opposite, in the direction of movement D of the motorized drive device 10 along the rail 4, of the second guide wheel 38b, 40b of the respective first holding device 37 or second holding device 39, so that the first and second guide wheels 38a, 38b, 40a, 40b can be inserted into or extracted from the rail 4, through the slot 5 of the rail 4.

Thus, the offset of the first guide wheel 38a, 40a of the respective first holding device 37 or second holding device 39, relative to the second guide wheel 38b, 40b of the respective first holding device 37 or second holding device 39, makes it possible to guarantee that the motorized drive device 10 is held relative to the rail 4, and, more particularly, that the first and second guide wheels 38a, 38b, 40a, 40b are brought into contact with the respective first and second rolling tracks 8a, 8b of the rail 4. Furthermore, the alignment of the first guide wheel 38a, 40a of the respective first holding device 37 or second holding device 39, relative to the second guide wheel 38b, 40b of the respective first holding device 37 or second holding device 39, allows the first and second guide wheels 38a, 38b, 40a, 40b to be inserted into or extracted from the rail 4, through the slot 5 of the rail 4.

In this way, the offset of the first and second guide wheels 38a, 38b, 40a, 40b of the respective first holding device 37 or second holding device 39, in the first position of the first and second switching mechanisms 41, 42, makes it possible to guarantee the movement of the motorized drive device 10 along the rail 4, by means of the drive wheel 13 and the electric motor 11. Furthermore, the alignment of the first and second guide wheels 38a, 38b, 40a, 40b of the respective first holding device 37 or second holding device 39, in the second position of the first and second switching mechanisms 41, 42, allows for easy insertion or extraction of the first and second guide wheels 38a, 38b, 40a, 40b relative to the rail 4, without having to disassemble the screen 2 or the rail 4.

Here, in the first position of the respective first switching mechanism 41 or second switching mechanism 42, the first guide wheel 38a, 40a of the respective first holding device 37 or second holding device 39, is offset relative to the second guide wheel 38b, 40b of the respective first holding device 37 or second holding device 39, in a transverse direction D′, visible in FIGS. 3 and 4, orthogonal to the direction of movement D of the motorized drive device 10 along the rail 4 and orthogonal to the translational movement M of the drive wheel 13 relative to the housing 43. Furthermore, in the second position of the respective first switching mechanism 41 or second switching mechanism 42, the second guide wheel 38b, 40b of the respective first holding device 37 or second holding device 39 is positioned, according to the transverse direction D′, at the same level as the first guide wheel 38a, 40a of the respective first holding device 37 or second holding device 39, so that the first and second guide wheels 38a, 38b, 40a, 40b can be inserted into or extracted from the rail 4, through the slot 5 of the rail 4. In other words, in the second position of the respective first switching mechanism 41 or second switching mechanism 42, the second guide wheel 38b, 40b of the respective first holding device 37 or second holding device 39 is aligned, with the first guide wheel 38a, 40a of the respective first holding device 37 or second holding device 39, in the direction D of movement of the motorized drive device 10 along the rail 4.

Such a motorized drive device 10 can thus easily be mounted or dismounted relative to the rail 4, without tools and, in particular, by a user.

Furthermore, such a motorized drive device 10 comprising the first holding device 37 and the second holding device 39 can be held, in other words suspended, to the rail 4 without having to make an adjustment of an element of this motorized drive device 10.

Advantageously, the first guide wheel 38a, 40a of the respective first holding device 37 or second holding device 39 is movable relative to the second guide wheel 38b, 40b of the respective first holding device 37 or second holding device 39. Furthermore, movement of the first guide wheel 38a, 40a of the respective first holding device 37 or second holding device 39, relative to the second guide wheel 38b, 40b of the respective first holding device 37 or second holding device 39, is implemented by the first and second switching mechanisms 41, 42.

Here, the movement of the first guide wheel 38a, 40a of the respective first holding device 37 or second holding device 39, relative to the second guide wheel 38b, 40b of the respective first holding device 37 or second holding device 39, implemented by means of the respective first switching mechanism 41 or second switching mechanism 42, is a rotational movement, preferably about an axis parallel to the transverse direction D′.

In a variant, not shown, the movement of the first guide wheel 38a, 40a of the respective first holding device 37 or second holding device 39, relative to the second guide wheel 38b, 40b of the respective first holding device 37 or second holding device 39, implemented by means of the respective first switching mechanism 41 or second switching mechanism 42, is a translational movement.

Advantageously, the second guide wheel 38b, 40b of the respective first holding device 37 or second holding device 39 is fixed relative to the housing 43 and, more particularly, relative to the wall 46 of the chassis 45.

Advantageously, the chassis 45 further comprises a first leg 53 and a second leg 54.

Here, the first and second legs 53, 54 extend inside the housing 43 from the wall 46 of the chassis 45 and, in particular, in a direction orthogonal to the wall 46 of the chassis 45.

Advantageously, the drive unit 49 is configured to be mounted, in other words is mounted, between the first and second legs 53, 54 of the chassis 45, in the assembled configuration of the motorized drive device 10.

Advantageously, the respective first holding device 37 or second holding device 39 further comprises at least a first arm 55a, 56a and a second arm 55b, 56b. The first arm 55a, 56a is connected, on the one hand, to the first guide wheel 38a, 40a of the respective first holding device 37 or second holding device 39, and, on the other hand, to the respective first switching mechanism 41 or second switching mechanism 42. Furthermore, the second arm 55b, 56b is connected, on the one hand, to the second guide wheel 38b, 40b of the respective first holding device 37 or second holding device 39, and, on the other hand, to the housing 43 and, more particularly, to the chassis 45, in this case to the wall 46 of the chassis 45.

Thus, the movement of the first guide wheel 38a, 40a of the respective first holding device 37 or second holding device 39, relative to the second guide wheel 38b, 40b of the respective first holding device 37 or second holding device 39, is implemented by a movement of the respective first arm 55a of the first holding device 37 or the first arm 56a of the second holding device 39, relative to the respective second arm 55b of the first holding device 37 or second arm 56b of the second holding device 39.

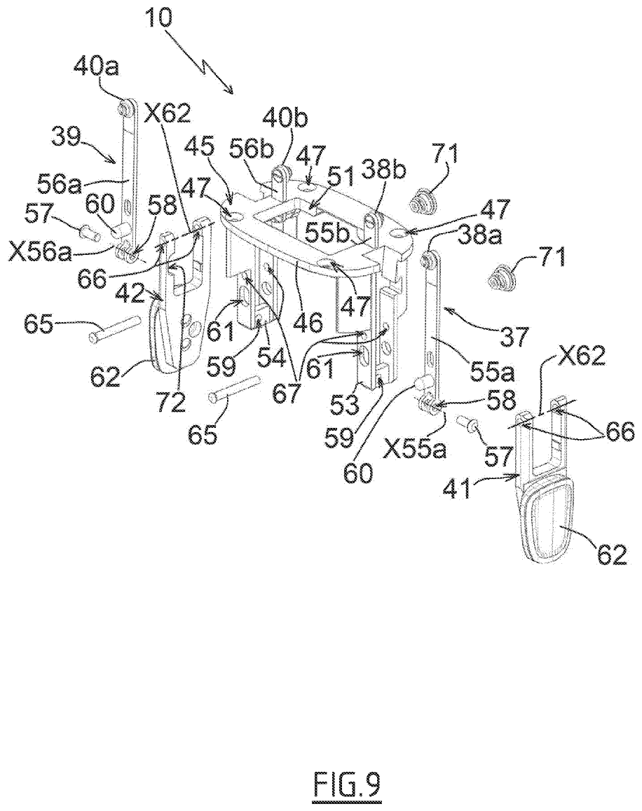

Advantageously, the first arm 55a, 56a of the respective first holding device 37 or second holding device 39 is rotatably mounted, about an axis of rotation X55a, X56a, relative to the chassis 45 and, more particularly, relative to the respective first leg 53 or second leg 54 of the chassis 45, as illustrated in FIG. 9.

Here and as illustrated in FIG. 9, the rotational movement of the first arm 55a, 56a of the respective first holding device 37 or second holding device 39, relative to the chassis 45, is implemented by means of a rotation shaft 57 inserted, on the one hand, in at least one opening 58 of the first arm 55a, 56a of the respective first holding device 37 or second holding device 39, and, on the other hand, in at least one opening 59 of the chassis 45 and, more particularly, of the respective first arm 53 or second arm 54 of the chassis 45.

Advantageously, the rotational movement of the first arm 55a, 56a of the respective first holding device 37 or second holding device 39, relative to the chassis 45, has limited travel.

Here and as illustrated in FIG. 9, the travel of the rotational movement of the first arm 55a, 56a of the respective first holding device 37 or second holding device 39, relative to the chassis 45, is determined by a stop 60 of the first arm 55a, 56a of the respective first holding device 37 or second holding device 39.

Advantageously, the stop 60 of the first arm 55a, 56a of the respective first holding device 37 or second holding device 39 is configured to interact, in other words interacts, with an opening 61 of the chassis 45 and, more particularly, of the respective first leg 53 or second leg 54 of the chassis 45, in particular of oblong shape.

Advantageously, the first arm 55a, 56a and the first guide wheel 38a, 40a of the respective first holding device 37 or second holding device 39 have a first cumulative thickness E1, in the assembled configuration of the motorized drive device 10, as illustrated in FIG. 3. The second arm 55b, 56b and the second guide wheel 38b, 40b of the respective first holding device 37 or second holding device 39 have a second cumulative thickness E2, in the assembled configuration of the motorized drive device 10, as illustrated in FIG. 3. Furthermore, the first cumulative thickness E1 of the first arm 55a, 56a and the first guide wheel 38a, 40a and the second cumulative thickness E2 of the second arm 55b, 56b and the second guide wheel 38b, 40b are respectively smaller than a width L of the slot 5 of the rail 4.

Here, the first cumulative thickness E1 of the first arm 55a, 56a and the first guide wheel 38a, 40a is equal to the second cumulative thickness E2 of the second arm 55b, 56b and the second guide wheel 38b, 40b.

Advantageously, the first and second guide wheels 38a, 38b of the first holding device 37 are respectively assembled by elastic snap-fitting onto the first and second arms 55a, 55b of the first holding device 37. Similarly, the first and second guide wheels 40a, 40b of the second holding device 39 are respectively assembled by elastic snap-fitting onto the first and second arms 56a, 56b of the second holding device 39.

Advantageously, the respective first switching mechanism 41 or second switching mechanism 42 comprises at least one button 62.

Advantageously, each button 62 is accessible, at a wall 63 of the housing 43, by a user in particular.

Here and as illustrated in FIG. 6, each button 62 is arranged through an opening 64 provided in the wall 63 of the housing 43. Only one opening 64 is visible in FIG. 6, the other opening being symmetrical to that visible in this figure relative to the median plane P.

Here, the motorized drive device 10 comprises two buttons 62. In such a case, the two buttons 62 are, preferably, arranged on two opposite sides of the housing 43.

Advantageously, the respective first button 62 or second button 62 is configured to switch the respective first switching mechanism 41 or second switching mechanism 42 between its first position and its second position.

Thus, when the first and second buttons 62 are actuated, the first and second switching mechanisms 41, 42 drive the first guide wheel 38a, 40a of the respective first holding device 37 or second holding device 39, relative to the second guide wheel 38b, 40b, between their first position and their second position.

In this way, after actuation of the first and second buttons 62, the first guide wheel 38a, 40a of the respective first holding device 37 or second holding device 39 is positioned opposite the second guide wheel 38b, 40b of the respective first holding device 37 or second holding device 39, so that the first and second guide wheels 38a, 38b, 40a, 40b can be inserted into or extracted from the rail 4, through the slot 5 of the rail 4.

As a result, the insertion or extraction of the first and second guide wheels 38a, 38b, 40a, 40b of the first and second holding devices 37, 39 into or from the rail 4 is implemented by aligning the first guide wheel 38a, 40a of the respective first holding device 37 or second holding device 39, in the direction of movement D of the motorized drive device 10 along the rail 4, with the second guide wheel 38b, 40b of the respective first holding device 37 or second holding device 39, by pressing the first and second buttons 62, in particular by means of two fingers of the same user hand.

Furthermore, when the first and second buttons 62 are pressed, the first and second switching mechanisms 41, 42 move, in particular along the translational movement M, the drive wheel 13 towards the interior of the housing 43 and, more particularly, the drive unit 49 towards the interior of the housing 43.

In this manner, upon actuation of the first and second buttons 62, the first elastic return elements 44 are compressed, so as to prevent the drive wheel 13 from bring into contact against the running surface 14 of the rail 4.

Moreover, when the first and second buttons 62 are released, the first and second switching mechanisms 41, 42 drive the first and second guide wheels 38a, 38b, 40a, 40b of the respective first holding device 37 or second holding device 39, between their second and first positions.

In this way, upon release of the first and second buttons 62, the second guide wheel 38b, 40b of the respective first holding device 37 or second holding device 39 becomes offset again, in the transverse direction D′, relative to the first guide wheel 38a, 40a of the respective first holding device 37 or second holding device 39, so that the first and second guide wheels 38a, 38b, 40a, 40b of the respective first holding device 37 or second holding device 39brought into contact with the first and second rolling tracks 8a, 8b of the rail 4.

Furthermore, when the first and second buttons 62 are released, the first and second switching mechanisms 41, 42 move, in particular along the translational movement M, the drive wheel 13 outwards from the housing 43 and, more particularly, the drive unit 49 outwards from the housing 43.

In this way, when the first and second buttons 62 are released, the first elastic return elements 44 relax, so as to bring into contact the drive wheel 13 against the running surface 14 of the rail 4.

Advantageously, the first button 62 of the respective first switching mechanism 41 or second button 62 of the second switching mechanism 42 is rotatably mounted, about an axis of rotation X62, relative to the chassis 45 and, more particularly, relative to the respective first leg 53 of the chassis 45 or second leg 54 of the chassis 45, as illustrated in FIGS. 9 to 11.

Here and as illustrated in FIG. 9, the rotational movement of the respective first button 62 of the first switching mechanism 41 or second button 62 of the second switching mechanism 42 is implemented by means of a rotation shaft 65 inserted, on the one hand, into at least one opening 66 of the respective first button 62 of the first switching mechanism 41 or second button 62 of the second switching mechanism 42, and, on the other hand, into at least one opening 67 of the chassis 45 and, more particularly, of the respective first leg 53 of the chassis 45 or second leg 54 of the chassis 45.

Here, the respective first button 62 of the first switching mechanism 41 or second button 62 of the second switching mechanism 42 comprises two openings 66. Furthermore, the chassis 45, in particular the first leg 53 of the chassis 45 and the second leg 54 of the chassis 45, comprises two openings 67 configured to interact with a rotation shaft 65 inserted in the two openings 66 of the first button 62 of the first switching mechanism 41 and two openings 67 configured to interact with a rotation shaft 65 inserted in the two openings 66 of the second button 62 of the second switching mechanism 42.

Advantageously, the translational movement M of the drive wheel 13 relative to the housing 43, when the first and second buttons 62 are actuated or released, is implemented by means of a cam 68 related to each of the first and second buttons 62, the cam 68 of each of the first and second buttons 62 being configured to interact with a pin 69 of the housing 50 of the drive unit 49, as illustrated in FIGS. 10 et 11. The cam 68 related to each of the first and second buttons 62 has been omitted in FIGS. 6, 7 and 9, for ease of reading.

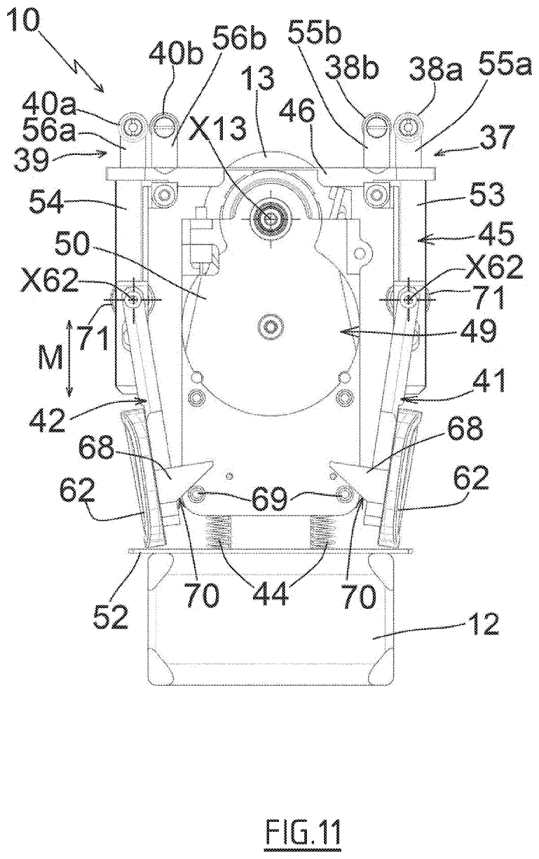

Here and as illustrated in FIGS. 10 and 11, the cam 68 of each of the first and second buttons 62 comprises a ramp 70. Furthermore, this ramp 70 is configured to interact with a pin 69 of the housing 50 of the drive unit 49, in the assembled configuration of the motorized drive device 10.

Advantageously, the motorized drive device 10 further comprises at least a second elastic return element 71.

Here and as illustrated in FIGS. 9 to 11, the motorized drive device 10 includes two second elastic return elements 71. Furthermore, each of the second elastic return elements 71 is configured to interact, in other words interacts, with one of the first and second switching mechanisms 41, 42, in the assembled configuration of the motorized drive device 10.

Here, each second elastic return element 71 is a spring, in particular a compression spring, and is formed as a spiral.

The number and shape of the second elastic return elements are not limiting and can be different. The number of second elastic return elements can be one, three or more. Furthermore, the or each second elastic return element can be a tension spring and can be made as a pin or can be a leaf spring.

Furthermore, one of the two second elastic return elements 71 is configured to tilt the respective first switching mechanism 41 or second switching mechanism 42 into an initial position, so as to drive the first guide wheel 38a, 40a of the respective first holding device 37 or second holding device 39, relative to the second guide wheel 38b, 40b of the respective first holding device 37 or second holding device 39, between its second position and its first position.

Advantageously, one of the two second elastic return elements 71 is configured to move the respective first button 62 or second button 62 to an initial position, called a rest position, by means of the first arm 55a, 56a.

Advantageously, when the first and second buttons 62 are actuated, the first and second switching mechanisms 41, 42 move the drive wheel 13 towards the interior of the housing 43 and, more particularly, the drive unit 49 towards the interior of the housing 43, then the first guide wheel 38a, 40a of the respective first holding device 37 or second holding device 39 is positioned opposite the second guide wheel 38b, 40b of the respective first holding device 37 or second holding device 39, so that the first and second guide wheels 38a, 38b, 40a, 40b can be inserted into or extracted from the rail 4, through the slot 5 of the rail 4.

Thus, such a succession of movements of the drive wheel 13 and, more particularly, of the drive unit 49, in a first step, and of the first and second guide wheels 38a, 38b, 40a, 40b of the respective first holding device 37 or second holding device 39, upon actuation of the first and second buttons 62, in a second step, facilitates the insertion of the first and second guide wheels 38a, 38b, 40a, 40b of the respective first holding device 37 or second holding device 39 into the rail 4, through the slot 5 of the rail 4.

In this way, the insertion of the first and second guide wheels 38a, 38b, 40a, 40b of the respective first holding device 37 or second holding device 39 into the rail 4, through the slot 5 of the rail 4, can be implemented without exerting any force on the rail 4, in particular by the user.

As a result, the insertion of the first and second guide wheels 38a, 38b, 40a, 40b of the respective first holding device 37 or second holding device 39 into the rail 4, through the slot 5 of the rail 4, can be implemented without having to press the drive wheel 13 against the rail 4 beforehand, in particular by the user.

Here, one of the two second elastic return elements 71 is configured to be mounted around the rotation shaft X62 of the first button 62 of the first switching mechanism 41 relative to the chassis 45, in particular the first leg 53 of the chassis 45, respectively around the rotation shaft X62 of the second button 62 of the second switching mechanism 42, relative to the chassis 45, in particular the second leg 54 of the chassis 45.

Advantageously, the first and second guide wheels 38a, 38b, 40a, 40b of the respective first holding device 37 or second holding device 39 have a respective diameter Ø, as illustrated in FIG. 10, greater than the width L of the slot 5 of the rail 4.

Thus, such a dimension of the first and second guide wheels 38a, 38b, 40a, 40b of the respective first holding device 37 or second holding device 39 makes it possible to improve an efficiency of the motorized drive device 10 during the electrical activation of the electric motor 11.

Furthermore, such a configuration of the motorized drive device 10 makes it possible to adapt the dimensions of the first and second guide wheels 38a, 38b, 40a, 40b of the respective first holding device 37 or second holding device 39 according to the dimensions of the rail 4.

Here and as illustrated in FIGS. 10 and 11, the diameter Ø of the first and second guide wheels 38a, 38b, 40a, 40b of the respective first holding device 37 or second holding device 39 is identical.

Here, the diameter Ø of the first and second guide wheels 38a, 38b, 40a, 40b of the respective first holding device 37 or second holding device 39 is smaller than a height H of the recess 6 of the rail 4, in other words a distance between the top wall 4a and the bottom wall 4b of the rail 4, as illustrated in FIG. 5.

Advantageously, the battery 12 is configured to be mounted, in other words is mounted, inside the housing 43, in particular at the bottom area of the housing 43, in the assembled configuration of the motorized drive device 10.

Here, in the assembled configuration of the motorized drive device 10, the battery 12 is brought into contact against the wall 63 of the housing 43. Furthermore, the support wall 52 is brought into contact against the battery 12.

In the assembled configuration of the occultation device 3, in the first position of the first and second switching mechanisms 41, 42 and when the electric motor 11 is electrically deactivated, the drive wheel 13 is brought into contact against the running surface 14 of the rail 4, via the first elastic return elements 44 bearing on the wall 63 of the housing 43 and, more particularly, on the bearing wall 52.

Thus, a force is exerted in a balanced manner on the first elastic return elements 44. This force is transmitted to the wall 63 of the housing 43 and then transmitted to the respective first and second guide wheels 38a, 38b, 40a, 40b of the first holding device 37 or the second holding device 39, which themselves transmit this force to the rail 4, at the first and second rolling tracks 8a, 8b of the rail 4.

In this way, the drive unit 49 is in a vertical position inside the housing 43 and, more particularly, in relation to the rail 4.

Furthermore, in this case, the axis of rotation X55a of the first arm 55a of the first holding device 37 relative to the first leg 53 of the chassis 45 and the axis of rotation X56a of the first arm 56a of the second holding device 39 relative to the second leg 54 of the chassis 45 are arranged in a plane parallel to the running surface 14 of the rail 4.

Moreover, the stop 60 of the first arm 55a, 56a of the first and second holding devices 37, 39 is not brought into contact with an edge of the opening 61 of one of the first and second legs 53, 54 of the chassis 45.

In the first position of the first and second switching mechanisms 41, 42 and when the electric motor 11 is electrically activated, in particular in the assembled configuration of the occultation device 3, the drive wheel 13 is brought into contact against the running surface 14 of the rail 4, by means of the first elastic return elements 44 brought into contact on the wall 52 arranged, in other words provided, in the housing 43 and is rotated, about the axis of rotation X13, by means of the electric motor 11 and, eventually, the transmitting device 28.

Thus, a compression force is exerted on the first elastic return elements 44 causing a movement of the drive unit 49 inside the housing 43. This movement of the drive unit 49 inside the housing 43 depends on the direction of rotation of the electric motor 11 and, therefore, of the drive wheel 13.

In this way, the drive unit 49 is in an inclined position inside the housing 43 and, more particularly, relative to the rail 4.

As a result, an arching motion is generated within the motorized drive device 10 causing an increase in the force of the drive wheel 13 on the running surface 14 of the rail 4, so as to move the motorized drive device 10 along the rail 4.

Here, the stop 60 of the first arm 55a, 56a of the respective first holding device 37 or second holding device 39 is moved and then brought into contact with a ramp 72 of the respective first switching mechanism 41 or second switching mechanism 42, only one of which is visible in FIG. 9.

Thanks to the present invention, offsetting the first guide wheel of the respective first holding device or second holding device, relative to the second guide wheel of the respective first holding device or second holding device, makes it possible to guarantee that the motorized drive device is held relative to the rail and, more particularly, that the first and second guide wheels are brought into contact with the respective first and second rolling tracks of the rail. Furthermore, aligning the first guide wheel of the respective first holding device or second holding device, relative to the second guide wheel of the respective first holding device or second holding device, makes it possible for the first and second guide wheels to be inserted into or extracted from the rail, through the slot of the rail.

In this way, offsetting the first and second guide wheels of the respective first or second holding device into the first position of the respective first switching mechanism or second holding device makes it possible to guarantee the movement of the motorized drive device along the rail, by means of the drive wheel and the electric motor. Furthermore, aligning the first and second guide wheels of the respective first holding device or second holding device in the second position of the respective first switching mechanism or second holding device makes it possible to facilitate easy insertion or extraction of the first and second guide wheels relative to the rail, without having to disassemble a screen from the occultation device or the rail.

Numerous modifications can be made to the above-described embodiments without departing from the scope of the invention defined by the claims.

In a variant, not shown, the motorized drive device 10 comprises only the first holding device 37.

In a variant, not shown, the motorized drive device 10 comprises only the first switching mechanism 41. Furthermore, the motorized drive device 10 comprises only a button 62. In this case, the first switching mechanism 41 can be configured to interact with the first and second holding devices 37, 39 or only with the first holding device 37.

In a variant, not shown, the rail 4 can be, for example, circular in cross-section truncated by a flat spot, in particular at its lower side. In this case, the flat of the rail 4 comprises the slot 5 and forms the first and second rolling tracks 8a, 8b, as well as the running surface 14.

In a variant, not shown, the screen 2 has no support elements 7, in particular when the rail 4 has a circular cross-section truncated by a flat spot. In this case, the screen 2 comprises eyelets. Furthermore, the rail 4 is inserted through the eyelets of the screen 2, so that the screen 2 is suspended relative to the rail 4.

In a variant, not shown, where the occultation device 3 comprises two screens 2 and a single rail 4, the occultation device 3 comprises two motorized drive devices 10. In the assembled configuration of the occultation device 3, a first motorized drive device 10 is configured to be held to the rail 4, in other words suspended from the rail 4, and is configured to move along the rail 4, so as to close or open a first screen 2. Furthermore, a second motorized drive device 10 is configured to be held to the rail 4, in other words suspended from the rail 4, and is configured to move along the rail 4, so as to close or open a second screen 2.

Furthermore, the contemplated embodiments and variants can be combined to generate new embodiments of the invention, without departing from the scope of the invention defined by the claims.

1. A motorized drive device of an occultation or solar protection device, the motorized drive device being provided for moving at least one screen along a rail of the occultation or solar protection device according to a sliding movement, the motorized drive device comprising at least:
an electric motor,
a drive wheel, the drive wheel being configured to be rotated by means of the electric motor and to be brought into contact with at least one running surface of the rail, so as to move the motorized drive device along the rail in a direction of movement,
a first holding device, the first holding device comprising at least a first guide wheel and a second guide wheel, the first and second guide wheels being configured to be inserted into or extracted from the rail, through a slot of the rail, and to be brought into contact with at least a respective first and a second rolling tracks of the rail, so as to hold or release the motorized drive device relative to the rail, and
a first switching mechanism, the first switching mechanism being configured to drive at least the first guide wheel of the first holding device between a first position and a second position, and vice versa,
wherein, in a first position of the first switching mechanism, the first guide wheel of the first holding device is offset relative to the second guide wheel of the first holding device, so as to hold the motorized drive device relative to the rail by supporting first and second guide wheels with the respective first and second rolling tracks of the rail,
and wherein, in a second position of the first switching mechanism, the first guide wheel of the first holding device is positioned opposite the second guide wheel of the first holding device, in the direction of movement of the motorized drive device along the rail, so as to insert or extract the first and second guide wheels into or from the rail, through the slot of the rail.

2. The motorized drive device of an occultation or solar protection device according to claim 1, wherein the first guide wheel of the first holding device is movable relative to the second guide wheel of the first holding device and wherein in that a movement of the first guide wheel of the first holding device relative to the second guide wheel of the first holding device is implemented by the first switching mechanism.

3. The motorized drive device of an occultation or solar protection device according to claim 1, wherein the second guide wheel of the first holding device is fixed relative to a housing of the motorized drive device.

4. The motorized drive device of an occultation or solar protection device according to claim 3, wherein the first holding device further comprises at least a first arm and a second arm, the first arm being connected to the first guide wheel, on the one hand, and to the first switching mechanism, on the other hand, the second arm being connected to the second guide wheel, on the one hand, and to the housing, on the other hand.

5. The motorized drive device of an occultation or solar protection device according to claim 1, wherein the first switching mechanism further comprises at least a first button and wherein in that the first button is configured to operate the first switching mechanism, so as to drive the first guide wheel of the first holding device relative to the second guide wheel of the first holding device, between first position and its second position.

6. The motorized drive device of an occultation or solar protection device according to claim 1, wherein the motorized drive device further comprises at least one elastic return element and wherein the elastic return element is configured to tilt the first switching mechanism into an initial position, so as to drive the first guide wheel of the first holding device relative to the second guide wheel of the first holding device, between its second position and its first position.

7. The motorized drive device of an occultation or solar protection device according to claim 1,
where the motorized drive device further comprises:
a second holding device, the second holding device comprising at least a first guide wheel and a second guide wheel, the first and second guide wheels being configured to be inserted into or extracted from the rail, through the slot of the rail, and to be brought into contact by at least the respective first and second rolling tracks of the rail, so as to hold or release the motorized drive device relative to the rail,
a second switching mechanism, the second switching mechanism being configured to drive at least the first guide wheel of the second holding device between a first position and a second position, and vice-versa,
wherein, in the first position of the second switching mechanism, the first guide wheel of the second holding device is offset relative to the second guide wheel of the second holding device, so as to hold the motorized drive device relative to the rail by supporting the first and second guide wheels with the respective first and second rolling tracks of the rail,
and wherein, in the second position of the second switching mechanism, the first guide wheel of the second holding device is positioned opposite the second guide wheel of the second holding device, in the direction of movement of the motorized drive device along the rail, so as to insert or extract the first and second guide wheels into or from the rail, through the slot of the rail.

8. An occultation or solar protection device comprising at least:
a screen,
a rail, and
a motorized drive device according to claim 1, the screen being suspended from the rail and movable along the rail, by means of the motorized drive device.

9. The occultation or solar protection device according to claim 8, wherein the respective first and second guide wheels of the first holding device respectively have a diameter greater than a width of the slot of the rail.

10. The occultation or solar protection device according to claim 8, wherein the first arm and the first guide wheel of the first holding device have a first cumulative thickness, in an assembled configuration of the motorized drive device, wherein the second arm and the second guide wheel of the first holding device have a second cumulative thickness, in the assembled configuration of the motorized drive device, and wherein the first cumulative thickness of the first arm and of the first guide wheel and the second cumulative thickness of the second arm and of the second guide wheel are respectively smaller than a width of the slot of the rail.

11. A home automation installation, comprising an occultation or solar protection device according to a claim 8.

12. The motorized drive device of an occultation or solar protection device according to claim 2, wherein the second guide wheel of the first holding device is fixed relative to a housing of the motorized drive device.

13. The motorized drive device of an occultation or solar protection device according to claim 2, wherein the first switching mechanism further comprises at least a first button and wherein the first button is configured to operate the first switching mechanism, so as to drive the first guide wheel of the first holding device relative to the second guide wheel of the first holding device, between first position and its second position.

14. The motorized drive device of an occultation or solar protection device according to claim 3, wherein the first switching mechanism further comprises at least a first button and wherein the first button is configured to operate the first switching mechanism, so as to drive the first guide wheel of the first holding device relative to the second guide wheel of the first holding device, between first position and its second position.

15. The motorized drive device of an occultation or solar protection device according to claim 4, wherein the first switching mechanism further comprises at least a first button and wherein the first button is configured to operate the first switching mechanism, so as to drive the first guide wheel of the first holding device relative to the second guide wheel of the first holding device, between first position and its second position.

16. The motorized drive device of an occultation or solar protection device according to claim 2, wherein the motorized drive device further comprises at least one elastic return element and wherein the elastic return element is configured to tilt the first switching mechanism into an initial position, so as to drive the first guide wheel of the first holding device relative to the second guide wheel of the first holding device, between its second position and first position.

17. The motorized drive device of an occultation or solar protection device according to claim 3, wherein the motorized drive device further comprises at least one elastic return element and wherein the elastic return element is configured to tilt the first switching mechanism into an initial position, so as to drive the first guide wheel of the first holding device relative to the second guide wheel of the first holding device, between its second position and first position.

18. The motorized drive device of an occultation or solar protection device according to claim 4, wherein the motorized drive device further comprises at least one elastic return element and wherein the elastic return element is configured to tilt the first switching mechanism into an initial position, so as to drive the first guide wheel of the first holding device relative to the second guide wheel of the first holding device, between its second position and first position.

19. The motorized drive device of an occultation or solar protection device according to claim 5, wherein the motorized drive device further comprises at least one elastic return element and wherein the elastic return element is configured to tilt the first switching mechanism into an initial position, so as to drive the first guide wheel of the first holding device relative to the second guide wheel of the first holding device, between its second position and first position.

20. The motorized drive device of an occultation or solar protection device according to claim 2, wherein the motorized drive device further comprises:
a second holding device, the second holding device comprising at least a first guide wheel and a second guide wheel, the first and second guide wheels being configured to be inserted into or extracted from the rail, through the slot of the rail, and to be brought into contact by at least the respective first and second rolling tracks of the rail, so as to hold or release the motorized drive device relative to the rail,
a second switching mechanism, the second switching mechanism being configured to drive at least the first guide wheel of the second holding device between a first position and a second position, and vice-versa,
wherein, in the first position of the second switching mechanism, the first guide wheel of the second holding device is offset relative to the second guide wheel of the second holding device, so as to hold the motorized drive device relative to the rail by supporting the first and second guide wheels with the respective first and second rolling tracks of the rail,
and wherein, in the second position of the second switching mechanism, the first guide wheel of the second holding device is positioned opposite the second guide wheel of the second holding device, in the direction of movement of the motorized drive device along the rail, so as to insert or extract the first and second guide wheels into or from the rail, through the slot of the rail.
